(19) United States
(12) Patent Application Publication
(10) Pub. No.: US 2024/0240942 A1
(43) Pub. Date: Jul. 18, 2024

(54) Adjustable Spirit Level

(71) Applicant: Artur Gretkowski, Hunt, TX (US)

(72) Inventor: Artur Gretkowski, Hunt, TX (US)

(21) Appl. No.: 18/411,083

(22) Filed: Jan. 12, 2024

Related U.S. Application Data
(60) Provisional application No. 63/438,619, filed on Jan. 12, 2023.

(51) Int. Cl. G01C 9/28; G01C 9/34

(52) U.S. Cl. CPC G01C 9/28; G01C 9/34

(57) ABSTRACT

An adjustable spirit level device is disclosed. The level is adjustable in length to help leveling in different spaces and includes a main body having opposite ends, each end has a slidably attached retractable portion that can be extended independently in opposite directions to adjust the length of the level. Each retractable portion includes a pair of sliding rods, each rod passes through the main body and the other retractable portion, wherein when a retractable portion is extended, the corresponding sliding rods slide through the main body and the other retractable portion. The level contains bubble levels in different axes for precise leveling.

### CROSS-REFERENCE TO RELATED APPLICATION

The present application claims priority to, and the benefit of, U.S. Provisional Application No. 63/438,619, which was filed on Jan. 12, 2023, and is incorporated herein by reference in its entirety.

### FIELD OF THE INVENTION

The present invention generally relates to the field of leveling devices. More specifically, the present invention relates to a novel multifunctional level capable of making precise measurement markings in closed spaces like attics. The level includes two retractable ends slidable and detachably attached to the ends of the main body. Each retractable portion includes a pair of two sliding rods, each rod passes through the main body and the other retractable portion. The level can be extended or retracted in length for use. Accordingly, the present disclosure makes specific reference thereto. Nonetheless, it is to be appreciated that aspects of the present invention are also equally applicable to other like applications, devices, and methods of manufacture.

### BACKGROUND

By way of background, leveling and measuring are important steps in construction projects and DIY (do-it-yourself) tasks. Leveling ensures that surfaces and structures are built accurately and safely. More specifically, leveling is the process of determining the height of one point relative to another to ensure that surfaces are, for example, flat, level, vertical, or horizontal. Leveling not only provides proper alignment but also prevents spacing errors and improves aesthetics.

Leveling tools are used to achieve accurate measurements and leveling of different surfaces such as floors, walls, countertops, and more. Common leveling tools such as spirit levels, laser levels, and digital levels are used by operators for leveling surfaces. The majority of operators use spirit levels as they are easy to use, less expensive, and can be stored easily. However, standard leveling tools come in fixed lengths, which may not be suitable for all applications. Especially, in tight or confined spaces, a long level may be impractical, and a shorter one may be needed. For longer walls and surfaces, a long level is required. As a result, operators need to buy and store multiple leveling tools of different lengths which is expensive and difficult to maintain. Individuals desire a multifunctional level that can be adjusted in length to do easy and accurate leveling and measurement.

Therefore, there exists a long-felt need in the art for a multifunctional and adjustable level. Additionally, there is a long-felt need in the art for an adjustable level that can be adjusted in length to be used for leveling in closed spaces. Moreover, there is a long-felt need in the art for an improved level that enables users to adjust the level to a desired length to make measurements and leveling easier. Also, there is a long-felt need in the art for a level device that can be used by both professionals and DIY users. Further, there is a long-felt need in the art for an adjustable level that can be used easily in attics and other areas having tight sloping ceilings. Furthermore, there is a long-felt need in the art for an adjustable and multifunctional level that obviates the need of using separate levels of different lengths to work at a worksite. Finally, there is a long-felt need in the art for a multifunctional level to replace standard levels that cannot adjust in size to make leveling much easier and more convenient.

The subject matter disclosed and claimed herein, in one embodiment thereof, comprises an adjustable spirit level. The level comprising a generally cuboidal main body having a first end and a second end opposite to the first end, a first retractable portion detachably and slidably attached to the first end of the main body, a second retractable portion symmetrical to the first retractable portion and detachably and slidably attached to the second end, the adjustable spirit level is in a standard position when the first retractable portion is adhered to the first end of the main body and the second retractable portion is adhered to the second end of the main body and the adjustable spirit level is in an extended position when one or both the retractable portions are extended away from the main body. A first set of two sliding rods are attached to the first retractable portion and a second set of two sliding rods are attached to the second retractable portion. Each rod of the first set slides along the corresponding cavity disposed in the main body and holes disposed in the second retractable portion to extend the first retractable portion. Each rod of the second set slides along the corresponding cavity disposed in the main body and holes disposed in the first retractable portion to extend the second retractable portion.

In this manner, the adjustable spirit level of the present invention accomplishes all of the foregoing objectives and provides users with a multifunctional level capable of making precise measurement markings in different spaces by allowing adjustment in the length of the level using retractable portions. The two retractable ends allow length adjustments of the level and the sliding rods help in easy extension and retraction of the opposing end portions. The level replaces standard levels that cannot adjust in size (i.e., length), making it much easier and more convenient to level and measure areas on a worksite.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an adjustable spirit level. The level further comprising a main body having two opposite ends, a first retractable and extendable portion detachably and slidably attached to a first end of the main body, a second retractable and extendable portion detachably and slidably attached to a second end opposite to the first end of the main body. A first set of two sliding rods attached to the first retractable and extendable portion, each sliding rod passes through a respective cavity disposed in the main body and through a respective hole in the second retractable and extendable portion wherein the first retractable and extendable portion slides while maintaining a coupling with the main body using the first set of the sliding rods. A second set of two sliding rods is attached to the second retractable and extendable portion, each sliding rod passes through a respective cavity disposed in the main body and through a respective hole in the first retractable and extendable portion wherein the second retractable and extendable portion slides while maintaining a coupling with the main body using the second set of the sliding rods.

In another embodiment, an adjustable spirit level is disclosed. The level comprising a generally cuboidal main body having a first end and a second end opposite to the first end, a first retractable portion detachably and slidably attached to the first end of the main body, a second retractable portion symmetric to the first retractable portion and detachably and slidably attached to the second end, the adjustable spirit level is in a standard position when the first retractable portion is adhered to the first end of the main body and the second retractable portion is adhered to the second end of the main body and the adjustable spirit level is in an extended position when one or both the retractable portions are extended away from the main body. A first bubble level is disposed on the main body to provide level information in one plane of a leveling object. A second bubble level is disposed on the first retractable portion and is oriented on a different axis from the axis of the first bubble level. A third bubble level is disposed on the second retractable portion and is oriented in a direction different from the directions of the first bubble level and the second bubble level.

In yet another embodiment, an adjustable level is disclosed. The adjustable level includes three components including a main body, a first extendable and retractable portion, and a second extendable and retractable portion. Two sliding rods are attached to the first extendable portion and another set of two sliding rods are attached to the second extendable portion. The extendable and retractable portions can selectively be extended and retracted using sliding rods which are passed through the cavities disposed in the adjustable level for adjusting the length of the level.

In still a further embodiment, each retractable portion is about 1/16 of the total length of the level device in the standard position.

In yet still a further embodiment, each sliding rod can be round, flat, L-shaped, C-shaped, or of any other configuration.

In another embodiment, the level can be made of plastic, wood, metal, or any other material.

Numerous benefits and advantages of this invention will become apparent to those skilled in the art to which it pertains upon reading and understanding of the following detailed specifications.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of the adjustable level device of the present invention in a standard position in accordance with the disclosed structure;

FIGS. 2 and 3 illustrate perspective views of the adjustable spirit level of the present invention in an extended position in accordance with the disclosed structure;

FIG. 4 illustrates the first retractable portion and the second retractable portion removed from the main body in accordance with the disclosed structure; and

FIG. 5 illustrates a perspective view of the adjustable spirit level of the present invention with one retractable portion extended from the main body in accordance with the disclosed structure.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a multifunctional and adjustable level. Additionally, there is a long-felt need in the art for an adjustable level that can be adjusted in length to be used for leveling in closed spaces. Moreover, there is a long-felt need in the art for an improved level that enables users to adjust the level to a desired length to make measurements and leveling easier. Also, there is a long-felt need in the art for a level device that can be used by both professionals and DIY users. Further, there is a long-felt need in the art for an adjustable level that can be used easily in attics, areas having tight spaces, and other areas with odd working lengths. Furthermore, there is a long-felt need in the art for an adjustable and multifunctional level that obviates the need of using separate levels of different lengths to work at a worksite. Finally, there is a long-felt need in the art for a multifunctional level to replace standard levels that cannot adjust in size to make leveling much easier and more convenient.

The present invention, in one exemplary embodiment, is an adjustable spirit level. The level further comprising a main body, a first retractable and extendable portion detachably and slidably attached to a first end of the main body, a second retractable and extendable portion detachably and slidably attached to a second end opposite to the first end of the main body. At least a first set of two sliding rods attached to the first retractable and extendable portion, each sliding rod passes through a respective cavity disposed in the main body and through a respective hole in the second retractable and extendable portion. At least a second set of two sliding rods are attached to the second retractable and extendable portion, each sliding rod passes through a respective cavity disposed in the main body and through a respective hole in the first retractable and extendable portion.

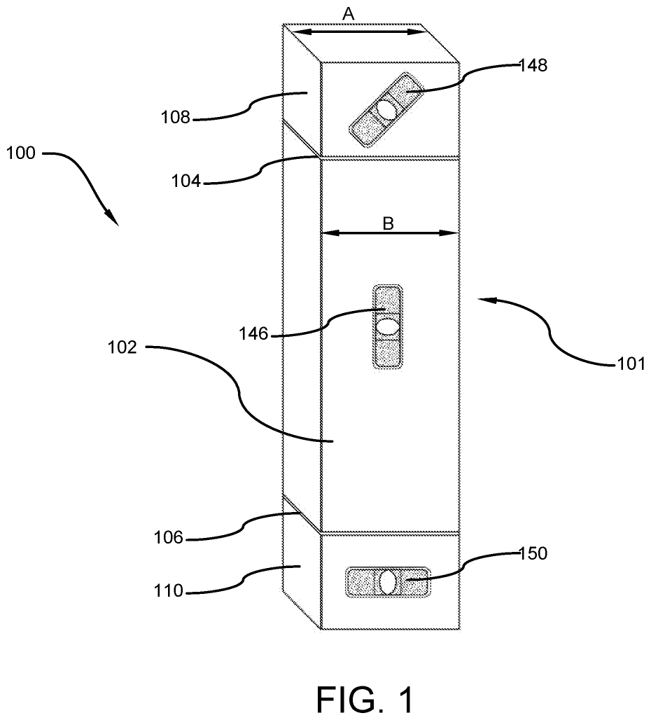

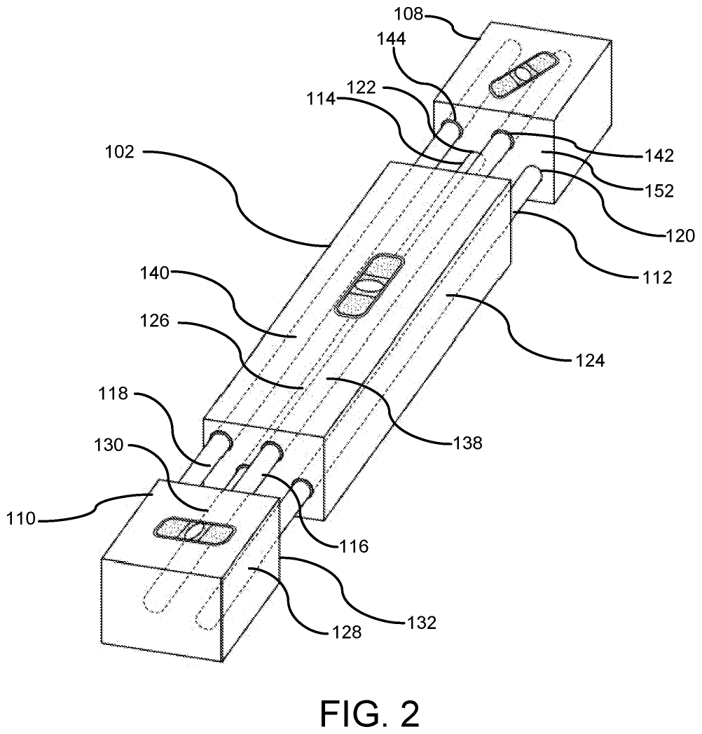

Referring initially to the drawings, FIG. 1 illustrates a perspective view of the adjustable level device of the present invention in a standard position in accordance with the disclosed structure. The adjustable level device 100 of the present invention is designed as a leveling tool that can be customized in length to level and measure easily and conveniently. More specifically, the adjustable spirit level 100 includes a generally cuboidal main body 102 having a first end 104 and a second end 106 opposite to the first end 104. A first retractable portion 108 is detachably and slidably attached to the first end 104 of the main body 102. The first retractable portion 108 has the same width (Arrow A) as of the width (Arrow B) of the main body 102 and is coupled to the main body 102 using a pair of sliding rods as illustrated in FIG. 2. A second retractable portion 110 symmetrical to the first retractable portion 108 is detachably and slidably attached to the second end 106. The first retractable portion 108 and the second retractable portion 110 can be similar in size and shape.

The adjustable spirit level 100 is in the standard position or non-extended position 101 when the first retractable portion 108 is adhered to the first end 104 of the main body 102 and the second retractable portion 110 is adhered to the second end 106 of the main body 102. The adjustable spirit level 100 can be extended by extending one or both retractable portions 106, 108 as illustrated in FIGS. 2, 3, and 5. In exemplary embodiments, each retractable portion is from about ½ to about 1/16 of the total length of the main body 102 in standard position.

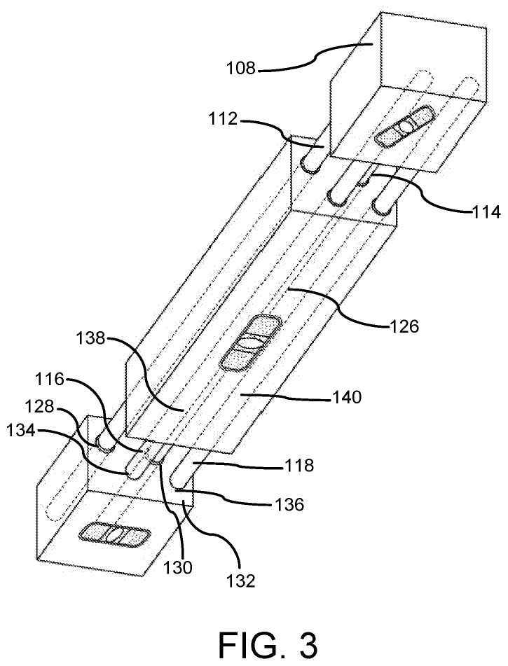

Referring to FIGS. 2 and 3, the spirit level 100 includes four sliding rods 112, 114, 116, 118 which can be of the same length or different lengths. The top end 120 of the first sliding rod 112 and the top end 122 of the second sliding rod 114 are fixed through the front surface 152 of the first retractable portion 108. The first sliding rod 112 and the second sliding rod 114 passes through the first cavity 124 and the second cavity 126 respectively of the main body 102. A pair of aligned openings/cavities 128, 130 are disposed in the front surface 132 of the second retractable portion 110. The first aligned opening 128 is colinearly aligned with the first cavity 124 and the second aligned opening 130 is colinearly aligned with the second cavity 126 of the main body 102. The first sliding rod 112 is adapted to slide through the first cavity 124 and moves into and out of the first aligned opening 128 of the second retractable portion 110 when the first retractable portion 108 is pulled away or pushed towards the main body 102 to adjust the length of the adjustable level device 100. Similarly, the second sliding rod 114 is adapted to slide through the second cavity 126 and then moves into and out of the second aligned opening 130. The sliding of the sliding rods 112, 114 helps the first retractable portion 108 to extend and retract to adjust the length of the level 100 while maintaining level alignment of portion 108 with main body 102.

The third sliding rod 116 and the fourth sliding rod 118 are fixed at their respective top ends 134, 136 in the front surface 132 of the second retractable portion 110. The third sliding rod 116 is adapted to pass through a third cavity 138 of the main body 102 and the fourth sliding rod 118 is adapted to pass through a fourth cavity 140 of the main body 102. A pair of aligned holes 142, 144 are disposed in the first retractable portion 108. The third aligned hole 142 is colinearly aligned with the third cavity 138 and the fourth aligned hole 144 is colinearly aligned with the fourth cavity 140. The third sliding rod 116 is adapted to slide through the third cavity 138 and moves into and out of the third aligned opening 142 of the first retractable portion 108. The fourth sliding rod 118 is adapted to slide through the fourth cavity 140 and moves into and out of the fourth aligned opening 144 of the first retractable portion 108. The sliding movement of the sliding rods 116, 118 allows the second retractable portion 110 to extend and retract to adjust length of the level 100 while maintaining level alignment of portion 110 with portion 108 and main body 102.

The cavities 124, 126, 138, 140 are disposed through the length of the main body 102 and extend between the opposite ends 104, 106. Further, the cavities 124, 126, 138, 140 are parallel to each other. The holes or openings 128, 130 may have continuous and parallel cavities for accommodating the sliding rods 112, 114, respectively. Similarly, the openings 142, 144 may have continuous and parallel cavities for accommodating the sliding rods 116, 118, respectively.

Referring again to FIG. 1, the main body 102 can have a first bubble level 146 disposed therein. The bubble level 146 is configured to provide level information in one plane of a leveling object. The first retractable portion 108 can have a second bubble level 148 which is oriented on a different axis from the axis of the first bubble level 146. Similarly, the second retractable portion 110 can have a third bubble level 150 oriented in a direction different from the directions of the first bubble level 146 and the second bubble level 148. The bubble levels 146, 148, 150 can help in leveling in 3-D space along different axes represented by the bubble levels 146, 148, 150.

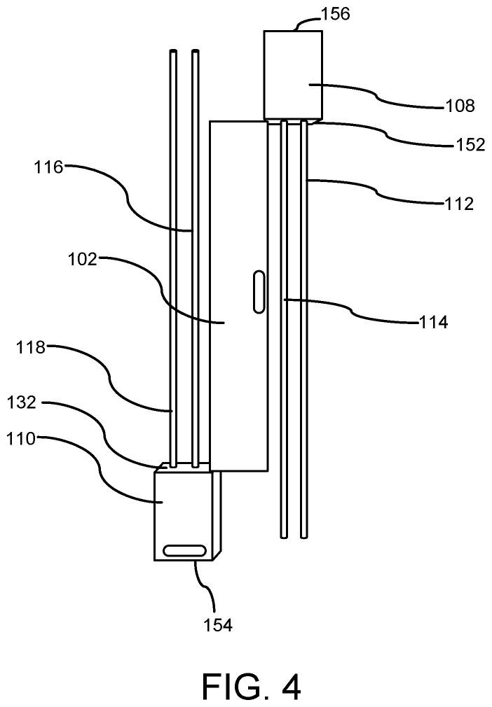

FIG. 4 illustrates the first retractable portion and the second retractable portion removed from the main body in accordance with the disclosed structure. In the preferred embodiment, the length of all the sliding rods 112, 114, 116, 118 is the same and is substantially equal to the sum of the length of the main body 102 and the length of the retractable portion which is opposite to the retractable portion to which the sliding rods are fixed or integrated. As illustrated, the length of the sliding rods 112, 114 extends from the front surface 152 of the first retractable portion 108 to the distal end 154 of the second retractable portion 110. Similarly, the length of the sliding rods 116, 118 extends from the front surface 132 of the second retractable portion 110 to the distal end 156 of the first retractable portion 108.

It will be apparent to a person skilled in the art that all the cavities in the main body 102 and the holes/cavities in the retractable/extendable portions 108, 110 are designed to accommodate the sliding rods and allow the sliding rods to slide without any friction. Furthermore, the sliding rods can be round, flat, L-shaped, C-shaped, or of any other configuration.

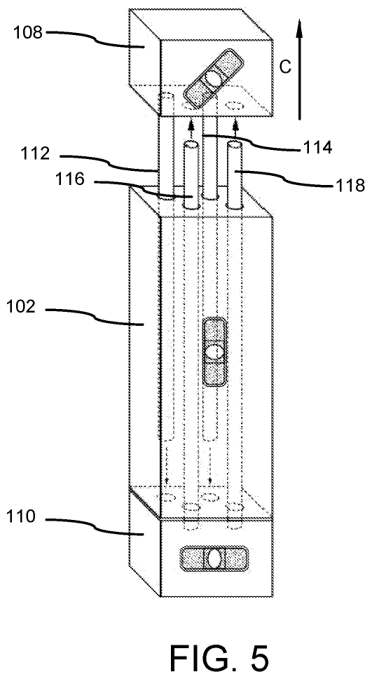

FIG. 5 illustrates a perspective view of the adjustable spirit level of the present invention with one retractable portion extended from the main body in accordance with the disclosed structure. As illustrated, for leveling an object or a surface and depending on the requirements of an operator, the first retractable portion 108 can be extended by pulling the portion 108 away from the main body 102 (Arrow C) such that the sliding rods 112, 114 fixed to the portion 108 maintains a sliding coupling between the main body 102 and the first retractable portion 108. Depending on the length of the level 100 required, the portion 108 can be extended in one direction while the second retractable portion 110 can be in a non-extended position. When the first retractable portion 108 is extended, the sliding rods 116, 118 can be decoupled from the first retractable portion 108 while maintaining coupling of the second retractable portion 110 and the main body 102. It is to be appreciated that portions 108, 110 can be selectively extended and retracted independently.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “adjustable level device”, “adjustable spirit level”, “spirit level”, “level device” and “level” are interchangeable and refer to the adjustable spirit level 100 of the present invention.

Notwithstanding the foregoing, the adjustable spirit level 100 of the present invention can be of any suitable size and configuration as is known in the art without affecting the overall concept of the invention, provided that it accomplishes the above-stated objectives. One of ordinary skill in the art will appreciate that the adjustable spirit level 100 as shown in the FIGS. 1-5 are for illustrative purposes only, and that many other sizes and shapes of the adjustable spirit level 100 are well within the scope of the present disclosure. Although the dimensions of the adjustable spirit level 100 are important design parameters for user convenience, the adjustable spirit level 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An adjustable spirit level device comprising:
a main body;
a first extendable and retractable portion; and
a second extendable and retractable portion for selectively adjusting a length of said spirit level device;
wherein said first portion extending and retracting from a first end of said main body;
wherein said second portion extending and retracting from a second end of said main body;
wherein said first portion is opposed to said second portion;
wherein said first portion and said main body having at least two sliding rods connecting said first portion to said main body for selective independent extension and retraction of said first portion; and
further wherein said second portion and said main body having at least two sliding rods connecting said second portion to said main body for selective independent extension and retraction of said second portion.

2. The adjustable spirit level device of claim 1, wherein said first portion having a first width and said main body having a main width, and further wherein said first width equal to said main width.

3. The adjustable spirit level device of claim 2, wherein said second portion having a second width and said main body having a main width, and further wherein said second width equal to said main width.

4. The adjustable spirit level device of claim 3, wherein said first width equal to said second width.

5. The adjustable spirit level device of claim 4, wherein said first portion having a first shape and said second portion having a second shape, and further wherein said first shape same as said second shape.

6. The adjustable spirit level device of claim 5, wherein each of said first portion and said second portion having a portion length and said main body having a main body length, and further wherein said portion length is from ½ to 1/16 of said main body length.

7. The adjustable spirit level device of claim 6, wherein said spirit level device having a cuboidal shape.

8. The adjustable spirit level device of claim 7, wherein said main body having a main bubble level disposed therein, said first portion having a first bubble level disposed therein, and said second portion having a second bubble level disposed therein, and further wherein said main bubble level, said first bubble level, and said second bubble level oriented in different directions.

9. An adjustable spirit level device comprising:
a main body;
a first extendable and retractable portion; and
a second extendable and retractable portion for selectively adjusting a length of said spirit level device;
wherein said first portion extending and retracting from a first end of said main body;
wherein said second portion extending and retracting from a second end of said main body;
wherein said first portion is opposed to said second portion;
wherein said first portion and said main body having at least one sliding rod connecting said first portion to said main body for selective independent extension and retraction of said first portion;
wherein said second portion and said main body having at least one sliding rod connecting said second portion to said main body for selective independent extension and retraction of said second portion;
wherein said main body having a main bubble level disposed therein, said first portion having a first bubble level disposed therein, and said second portion having a second bubble level disposed therein; and
further wherein said main bubble level, said first bubble level, and said second bubble level oriented in different directions.

10. The adjustable spirit level device of claim 9, wherein said first portion having a first width and said main body having a main width, and further wherein said first width equal to said main width.

11. The adjustable spirit level device of claim 10, wherein said second portion having a second width and said main body having a main width, and further wherein said second width equal to said main width.

12. The adjustable spirit level device of claim 11, wherein said first width equal to said second width.

13. The adjustable spirit level device of claim 12, wherein said first portion having a first shape and said second portion having a second shape, and further wherein said first shape same as said second shape.

14. The adjustable spirit level device of claim 13, wherein each of said first portion and said second portion having a portion length and said main body having a main body length, and further wherein said portion length is from ½ to 1/16 of said main body length.

15. The adjustable spirit level device of claim 14, wherein said spirit level device having a cuboidal shape.

16. An adjustable spirit level device comprising:
a main body;
a first extendable and retractable portion; and
a second extendable and retractable portion for selectively adjusting a length of said spirit level device;
wherein said first portion extending and retracting from a first end of said main body;
wherein said second portion extending and retracting from an opposing second end of said main body;
wherein said first portion and said main body having at least a first sliding rod connecting said first portion to said main body for selective independent extension and retraction of said first portion relative to said main body;
wherein said second portion and said main body having at least a second sliding rod connecting said second portion to said main body for selective independent extension and retraction of said second portion relative to said main body;
wherein said main body having a main bubble level disposed therein, said first portion having a first bubble level disposed therein, and said second portion having a second bubble level disposed therein;
wherein said first sliding rod of said first portion extending from a front surface of said first portion to a distal end of said second portion; and
further wherein said second sliding rod of said second portion extending from a front surface of said second portion to a distal end of said first portion.

17. The adjustable spirit level device of claim 16, wherein said main bubble level, said first bubble level, and said second bubble level oriented in different directions.

18. The adjustable spirit level device of claim 17, wherein said first portion having a first width and said main body having a main width, and further wherein said first width equal to said main width.

19. The adjustable spirit level device of claim 18, wherein said second portion having a second width and said main body having a main width, and further wherein said second width equal to said main width.

20. The adjustable spirit level device of claim 19, wherein each of said first portion and said second portion having a portion length and said main body having a main body length, and further wherein said portion length is from ½ to 1/16 of said main body length.
